(19) United States
(12) Patent Application Publication
(10) Pub. No.: US 2026/0340896 A1
(43) Pub. Date: Oct. 29, 2026

(54) BIHARMONIC GRADIENT SEGMENTATION AND RECONSTRUCTION

(71) Applicant: Adobe Inc., San Jose, CA (US)

(72) Inventors: Natalia PACHECO-TALLAJ, Cambridge, MA (US); Michal LUKÁC, Boulder Creek, CA (US); Siddhartha CHAUDHURI, New Haven, CT (US); Matthew FISHER, Burlingame, CA (US); Kevin WAMPLER, Seattle, WA (US); Alec JACOBSON, Toronto (CA)

(21) Appl. No.: 19/191,470

(22) Filed: Apr. 28, 2025

(51) Int. Cl. G06T 11/60; G06T 7/11; G06T 7/12; G06T 11/40

(52) U.S. Cl. CPC G06T 11/60; G06T 7/11; G06T 7/12; G06T 11/40

(57) ABSTRACT

In some implementations, an image processing device may segment a raster image into multiple piecewise smooth regions. The image processing device may identify, for each region of the multiple piecewise smooth regions, a respective set of control points that approximates the region as a biharmonic gradient. The image processing device may generate a set of vector primitives that approximates the raster image according to a set of biharmonic gradient fill values that are based on the respective set of control points for each region of the multiple piecewise smooth regions. The image processing device may generate a vector graphics file based on the set of vector primitives.

### BACKGROUND

Raster graphics and vector graphics are two common file formats that are often used to represent digital images. For example, raster graphics are composed from pixels arranged in a grid, with each pixel having a respective color and brightness. In large quantities, the pixels can form highly detailed images, such as photographs, and the quality associated with a raster image depends on how many pixels are used to represent the image (with larger pixel quantities resulting in higher image quality, and vice versa). In contrast, vector graphics contain no pixels, and instead use mathematical equations, lines, and curves with fixed points on a grid to represent an image. For example, the mathematical formulas associated with a vector graphics file use geometric primitives such as points, lines, Bezier curves, and gradients to capture shapes, borders, fill colors, and/or other image features. Accordingly, vector graphics files tend to be more compact (e.g., have smaller file sizes) than raster graphics files, and are resolution independent (e.g., infinitely scalable to larger or smaller sizes without impacting image quality) because the mathematical formulas recalibrate to any size.

### SUMMARY

Implementations described herein generally relate to techniques to vectorize a raster image that includes one or more regions or areas filled with a biharmonic gradient, also known as a freeform gradient, where colors at isolated points or curves within a shape gradually transition or blend according to a biharmonic response that results in a color blending that appears smooth and natural. For example, in some implementations, an image processing device segments a raster image into an approximation that includes one or more closed, piecewise smooth regions (e.g., regions that are bounded by a finite union of smooth curves) that are free from high-frequency interior features such as edges or discontinuities. The image processing device then extracts or otherwise identifies a set of control points, or handles, that control values associated with a biharmonic fill function for each piecewise smooth region. For example, based on a set of control points within a shape and a respective color value at each control point, the biharmonic fill function is used to interpolate color values at each mesh vertex within the shape into the entire shape. Accordingly, to configure the biharmonic fill function in a given region, the image processing device identifies a set of colors that minimizes a difference from target pixel and vertex values in the region of the raster image, and local maxima of a biharmonic or bilaplacian operator associated with the set of colors are identified as the control points for the region. The image processing device then establishes a respective color value for each control point to configure the biharmonic fill function in the given region.

In some implementations, a method may include segmenting a raster image into multiple piecewise smooth regions; identifying, for each region of the multiple piecewise smooth regions, a respective set of control points that approximates the region as a biharmonic gradient; generating a set of vector primitives that approximates the raster image according to a set of biharmonic gradient fill values that are based on the respective set of control points for each region of the multiple piecewise smooth regions; and generating a vector graphics file based on the set of vector primitives.

In some implementations, a system may include a memory component and a processing device coupled to the memory component. The processing device may be configured to segment an input image into one or more piecewise smooth regions; identify, for each region of the one or more piecewise smooth regions, a respective set of control points that approximates the region as a biharmonic gradient, wherein the respective set of control points associated with each region have a non-zero biharmonic response; generate a set of vector primitives that approximates the input image according to a set of biharmonic gradient fill values, wherein the set of biharmonic gradient fill values are based on color values for the respective set of control points associated with each region of the one or more piecewise smooth regions; and generate a vector graphics file based on the set of vector primitives.

In some implementations, a method may include detecting a set of edges in an input image using a piecewise smooth functional; forming a set of closed, piecewise smooth regions based on the set of edges using a spectral processing algorithm; identifying, for each region of the set of closed, piecewise smooth regions, a respective set of control points that approximates the region as a biharmonic gradient; generating a set of vector primitives that approximates the input image according to a set of biharmonic gradient fill values that are based on the respective set of control points for each region of the set of closed, piecewise smooth regions; and generating a vector graphics file based on the set of vector primitives.

Implementations described herein generally include a method, a system, a device, a non-transitory computer-readable medium, and/or an apparatus, as substantially described herein with reference to and as illustrated by the drawings and specification.

The foregoing has broadly outlined the features and technical advantages of examples described herein such that that the detailed description that follows may be better understood. Additional features and advantages will be described hereinafter. The conception and specific examples described herein may be readily utilized as a basis to modify or design other implementations for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is a diagram illustrating examples associated with vectorizing a raster image, according to some implementations of the present disclosure.

FIG. 2 is a diagram illustrating an example associated with generating a vector graphics reconstruction of a raster image with one or more biharmonic gradients, according to some implementations of the present disclosure.

FIGS. 3A-3D are diagrams illustrating examples associated with generating a vector graphics reconstruction of a raster image with one or more biharmonic gradients, according to some implementations of the present disclosure.

FIG. 4 is a diagram illustrating an example environment in which a raster image with one or more biharmonic gradients may be converted to a vector graphics file, according to some implementations of the present disclosure.

FIG. 5 is a diagram illustrating an example process associated with biharmonic gradient segmentation and reconstruction, according to some implementations of the present disclosure.

FIG. 6 is a diagram illustrating an example device associated with biharmonic gradient segmentation and reconstruction, according to some implementations of the present disclosure.

FIG. 7 is a diagram illustrating an example image processing apparatus configured to generate a vector graphics reconstruction of a raster image with one or more biharmonic gradients, according to some implementations of the present disclosure.

### DETAILED DESCRIPTION

The following detailed description of example implementations refers to the accompanying drawings. The same reference numbers in different drawings may identify the same or similar elements.

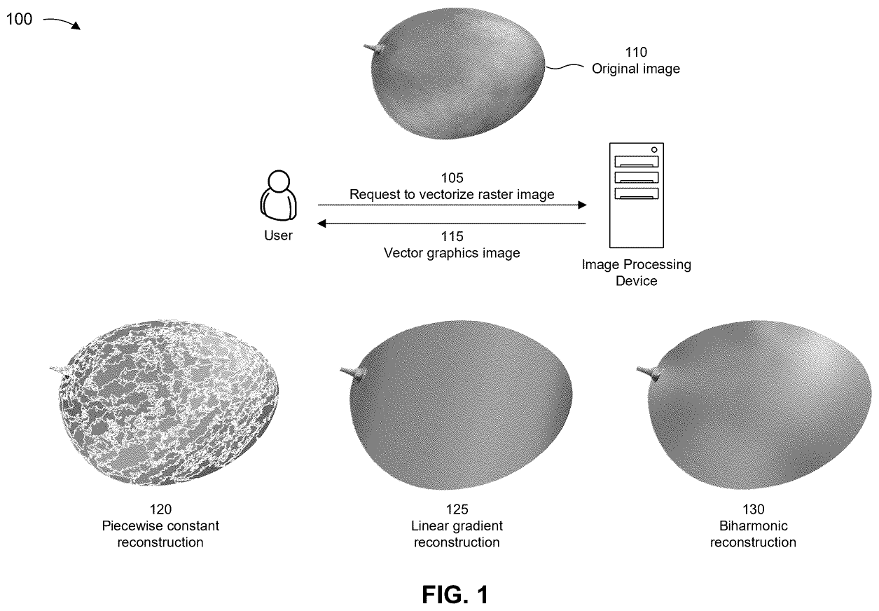

FIG. 1 is a diagram illustrating examples 100 associated with vectorizing a raster image, according to some implementations of the present disclosure. As shown in FIG. 1, a user interacts with an image processing device that executes or supports an image processing application. For example, the image processing application provides image editing and/or design capabilities, such that a user interacts with the image processing application via a suitable user interface to edit and/or design images. In some implementations, the image processing device may be a user device that executes the image processing application, a server that executes the image processing application and provides a user interface for interacting with the user via a user device, or a server that performs processing tasks to support the image processing application executing on the user device, among other examples. In some implementations, the image processing application may provide various features to enable the user to edit and/or design vector graphics files (e.g., in file formats such as Scalable Vector Graphics (SVG), Encapsulated PostScript (EPS), or Portable Document Format (PDF)).

Vector graphics represent digital images with geometric primitives such as points, lines, Bezier curves, and gradients. In contrast to raster images that represent digital images according to a pixel grid, vector graphics are defined according to mathematical equations, which results in vector graphics files tending to be more compact than raster graphics files (e.g., with file sizes often measured in kilobytes in contrast to raster graphics that often have file sizes measured in megabytes). In addition, vector graphics are resolution independent, which allows vector graphics to be infinitely scalable without any reduction in image quality. Accordingly, vector graphics are widely used in graphics design to represent logos, icons, illustrations, and/or other images where a crisp image quality and/or compact file size is desired. Furthermore, because much digital imagery is available in raster form only, vectorization techniques to convert raster images into vector graphics are important and widely used tools in the graphics industry.

For example, as shown by reference number 105 in FIG. 1, a user provides a request to vectorize a raster image to the image processing device, where the request is provided by selecting an option, providing a command, or otherwise invoking a feature to convert a raster image (or other suitable non-vector image) to a vector image using the image processing application executed or supported by the image processing device. For example, the user provides an original image 110 that is not in a vector graphics format to the image processing device, and the image processing device then converts the original image 110 to a vector graphics image. As shown by reference number 115, the image processing device then returns the vector graphics image to the user (e.g., as a vector graphics file).

For example, as described herein, vectorizing a raster image typically includes a segmentation step, a fill extraction step, and a curve tracing step. In the segmentation step, the image processing device divides the raster image 110 into regions that can be approximated with geometric primitives and fill primitives using a segmentation algorithm that trades off fidelity to the original raster image 110 for complexity of the approximation (e.g., based on the quantity of regions, boundary lengths, and/or other parameters associated with the segmentation). For example, the user requests a vector graphics reconstruction that is a close approximation of the original raster image 110, which increases the segmentation complexity (e.g., increasing the vectorization processing time, increasing the file size of the vector graphics image, and/or increasing the editing complexity for the vector graphics image), or the user requests a vector graphics reconstruction that is a rougher approximation of the original raster image 110, which decreases the segmentation complexity. In some implementations, the image processing application provides the user with an option to configure the fidelity and/or complexity associated with the vectorization of the original raster image 110. In the fill extraction step, an optimal fill (e.g., parametric color distribution) is reconstructed for each region. Finally, after the regions and fills have been extracted, the tracing step converts pixel masks associated with the regions into Bezier shapes by fitting curves to the boundary (e.g., by computing Bezier curves or other mathematical representations bounding the shapes of the segmented regions).

When vectorizing the raster image 110, the segmentation algorithm divides the image into regions according to the fill types that can be fitted to each segment, such that the segments are neither excessively complex for individual fills nor overly numerous. For example, the image processing device supports vectorization based on a solid fill, where the segmentation step divides the raster image 110 into (approximately) piecewise-constant color regions, such that each region may be filled with the average color of the pixels in the region (e.g., by binning neighboring pixels with the same color into connected components). For example, FIG. 1 depicts an example piecewise constant reconstruction 120 of the original raster image 110, where each segment has a solid fill corresponding to the average color of the pixels in the segment. However, solid fills have various drawbacks. For example, as shown in the piecewise constant reconstruction 120, solid fills can result in banding artifacts in regions with color gradients and/or a fine-grained decomposition that makes editing inefficient and time-consuming.

Accordingly, in some cases, higher-order fill primitives such as linear gradients, radial gradients, gradient meshes, and freeform gradients (also known as diffusion curves) may be used to individually represent complex (smooth) distributions. For example, FIG. 1 depicts an example linear gradient reconstruction 125 of the original raster image 110, where colors blend from one point to another in a straight line. To generate the linear gradient reconstruction 125, the image processing device segments the raster image 110 into piecewise affine regions (rather than piecewise constant regions) in which color is represented as an affine function of pixel positions. To extract the linear gradient fill, the image processing device merges neighboring regions with affine color functions that have the same direction, and then extracts a color ramp function that determines a respective color for each pixel as a function of where the pixel is located along an axis. However, because the linear gradient fill is limited to affine functions, each linear gradient has a fixed complexity and regions that could be expressed as a single linear gradient with a richer color map are instead broken up into sub-segments.

Accordingly, the image processing device supports one or more freeform gradient fills, which include biharmonic diffusion or thin-plate spline diffusion variants that allow various boundary conditions (e.g., including curve and point constraints). For example, to create a freeform gradient using the image processing application, the user may create a graduated blend of color stops within a shape in an ordered or random sequence, such that the color blending appears smooth and natural. For example, the image processing application enables the user to create a freeform gradient in a point mode, where a color stop is assigned a color and an area around the color stop is shaded with a gradient, or in a line mode, where a line is assigned a color and an area around the line is shaded with a gradient. Accordingly, higher-order gradient fills, such as diffusion from sparse control primitives via harmonic or biharmonic partial differential equations, provide artists with the ability to expressively represent intricate fills with sparse controls. Furthermore, higher-order gradient fills can alleviate the burden on the segmentation step in a vectorization pipeline. For example, each segment with a smoothly varying color is likely able to be well-approximated with a high-order freeform gradient fill, such as biharmonic diffusion. In addition, a single high-order fill is easier to edit than a large collection of lower-order fills. However, fitting a high-order gradient with minimal parameters to a complex color distribution poses significant challenges. For example, techniques to trace gradient meshes and gradient curves are generally heuristic and rely on edge filters to extract geometry, and techniques to trace diffusion curves do not address segmentation and instead treat the entire image as a single fill, and/or lack support for point constraints in gradients based on biharmonic diffusion. The lack of segmentation-aware techniques limits integrating biharmonic gradients and other advanced gradients into vectorization pipelines.

Accordingly, some implementations described herein relate to techniques to vectorize a raster image to generate a biharmonic reconstruction of the raster image. For example, FIG. 1 illustrates an example biharmonic reconstruction 130 that vectorizes the raster image 110 using a piecewise biharmonic gradient fill in accordance with some implementations described herein. For example, to generate the biharmonic reconstruction 130, the image processing device segments the raster image 110 into an approximation that includes one or more closed, piecewise smooth regions (e.g., regions that are bounded by a finite union of smooth curves) that are free from high-frequency interior features such as edges or discontinuities. The image processing device then extracts or otherwise identifies a set of control points, or handles, that control values associated with a biharmonic fill function for each piecewise smooth region. For example, based on a set of control points within a shape and a respective color value at each control point, the biharmonic fill function is used to interpolate color values at each mesh vertex within the shape into the entire shape. Accordingly, to configure the biharmonic fill function in a given region, the image processing device identifies a set of colors that minimizes a difference from target pixel and vertex values in the region of the raster image 110, and local maxima of a biharmonic or bilaplacian operator associated with the set of colors are identified as the control points for the region. The image processing device then establishes a color value for each control point to configure the biharmonic fill function in the given region.

In this way, some implementations described herein create vector graphics files representing or approximating raster images using biharmonic fills that have fidelity to expressive color variations and color blending in the original raster images. Furthermore, the vector graphics files representing or approximating raster images have a more compact size than the approximated raster images, and are infinitely scalable with no reduction in image quality. In addition, by extracting a single biharmonic gradient fill to accurately represent a complex color distribution in a region of a raster image, some implementations described herein significantly reduce the processing resources and processing time associated with the segmentation step in a vectorization pipeline (e.g., because the raster image can be segmented into larger regions that have smoothly varying colors). Furthermore, the vector graphics file represents one or more regions using a single higher-order biharmonic gradient fill, which is significantly easier to edit than a piecewise constant reconstruction with many lower-order fills.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

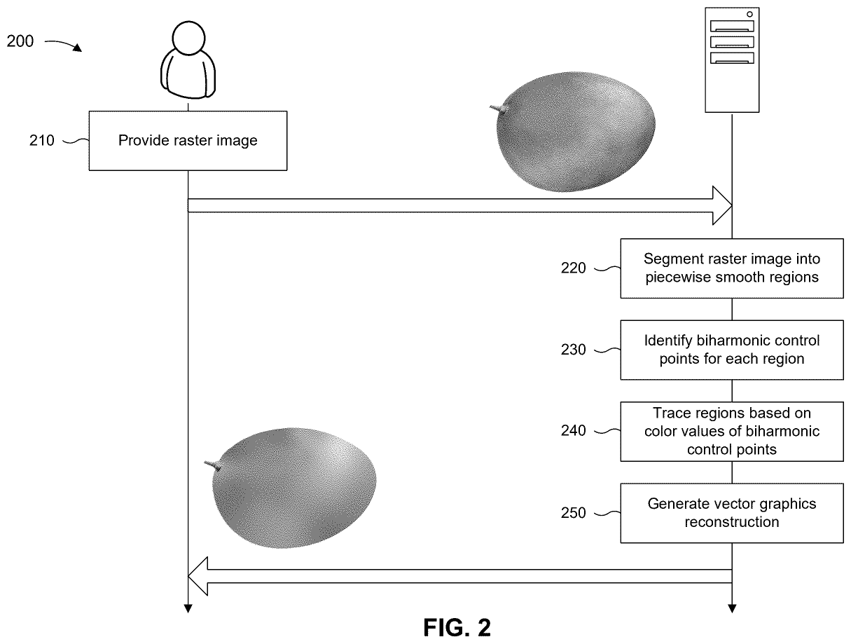

FIG. 2 is a diagram illustrating an example 200 associated with generating a vector graphics reconstruction of a raster image with one or more biharmonic gradients, according to some implementations of the present disclosure. As shown in FIG. 2, a user interacts with an image processing device that executes or supports an image processing application. For example, the image processing application includes image editing and/or design capabilities, such that the user interacts with the image processing application via a suitable user interface to edit and/or design images. In some implementations, the image processing device may be a user device that executes the image processing application, a server that executes the image processing application and provides a user interface for interacting with the user via a user device, or a server that performs processing tasks to support the image processing application executing on the user device, among other examples. In some implementations, the image processing application provides various features to enable the user to edit and/or design vector graphics files (e.g., in file formats such as SVG, EPS, or PDF, among other examples).

As shown in FIG. 2, and by reference number 210, the user provides, to the image processing device, a raster image to be vectorized. In some examples, the raster image includes one or more regions with smoothly varying colors that can be approximated using a high-order freeform gradient, such as biharmonic diffusion. Accordingly, as described herein, the image processing device performs one or more tasks associated with a vectorization pipeline to generate a vector graphics file that approximates (or reconstructs) the raster image, where the vector graphics file includes one or more regions with a biharmonic gradient fill.

More particularly, as shown by reference number 220, a first step in the vectorization pipeline includes segmenting the raster image into multiple piecewise smooth regions. In some implementations, the raster image is segmented using a segmentation algorithm that provides a tradeoff between fidelity to the raster image and a complexity of the approximation. For example, the user may request a higher fidelity approximation of the raster image, which results in a more complex segmentation (e.g., a larger number of regions or smaller boundaries), or may request a lower fidelity approximation of the raster image, which results in a less complex segmentation. In some implementations, the image processing device provides the user with options to selectably control the fidelity and/or complexity associated with the segmentation (e.g., using a slider user interface element or other suitable options).

In some implementations, the image processing device segments the raster image into the piecewise smooth regions using a piecewise smooth variant of a functional (e.g., a Mumford-Shah functional) that least-squares approximates a target function ƒ representing the image to be vectorized by a piecewise constant function x, subject to a penalty for the total length of a boundary between the constant pieces. For example, in a discrete setting, both the target function ƒ and the approximation x are sampled on a grid, and a length of the boundary is equivalent to a total number of pixels in which a color value changes (e.g., where the gradient of the approximation x is non-zero), according to:

$${min}_{x} {‖ x - f ‖}^{2} + λ {‖ ∇ x ‖}_{0} \qquad ( 1 )$$

where x is the approximation of the target image ƒ, λ is a parameter used to tradeoff fidelity for complexity, and ∇ is a Laplace (or Laplacian) operator, which is a differential operator given by the divergence of a gradient of a scalar function on a Euclidean space. In the Mumford-Shah expression in Expression 1, the ∥x−ƒ∥² term is minimized to minimize the difference between the target image and the approximation of the target image, and the ∥∇x∥₀ term is an L₀ gradient penalty based on the number of pixels in the approximation x that have a non-zero gradient (e.g., the number of pixels that are adjacent to a pixel with a different color). The Mumford-Shah functional results in a piecewise constant segmentation, and the image processing device segments the raster image into piecewise smooth regions using a primal-dual proximal algorithm that applies a thresholded L₂ gradient penalty given by min(α|∇x|², λ), where the L₂ gradient is the sum of the squares of the individual gradients, and setting α=∞ yields a piecewise-constant approximation of the target image ƒ with the fidelity-complexity tradeoff controlled by λ. In a piecewise-constant segmentation, the approximation is segmented by finding connected components of pixels with equal colors, and then setting each segment to have a solid fill corresponding to the color of the pixels therein.

Accordingly, in some implementations, the image processing device segments the raster image into piecewise smooth regions by selecting a suitable value for X to control the fidelity-complexity tradeoff, and by selecting a suitable value for a according to a desired degree of smoothing (e.g., to reduce noise or fine details in the image, where lower values for a result in a higher degree of smoothing). The smoothed image approximating the raster image can then be segmented into connected components (or regions) that are piecewise smooth and sufficiently distinct in color using spectral mesh segmentation techniques, where neighboring pixels are considered to be connected if

$${‖ {x}_{i} - {x}_{j} ‖}^{2} \leq \frac{λ}{α} .$$

Although the vectorization pipeline is described herein as segmenting the raster image into multiple piecewise smooth regions, in some cases, the raster image is approximated as a single biharmonic diffusion region (e.g., the entire raster image is treated as one region or segment with a biharmonic gradient fill). However, in some cases (e.g., where the raster image includes high-frequency interior features, such as edges), approximating the raster image as a single region increases complexity of the fill extraction step (described in more detail below) beyond a practical level (e.g., the fill extraction may have an impractical computational burden). Additionally, or alternatively, the single region may be a poor fit for a biharmonic gradient that is not well-suited to represent discontinuities (e.g., significant color changes between adjacent or neighboring pixels). Accordingly, in some implementations, the image processing device analyzes the raster image to determine whether the raster image includes high-frequency features, and skips the segmentation step in cases where the entire image can be well-approximated as a single biharmonic diffusion region. Alternatively, in cases where the raster image has high-frequency features, the image processing device traces the interior edges and use a semi-closed region segmentation algorithm to obtain regions that are free from interior edges, and the regions are then approximated using the techniques described herein.

As further shown in FIG. 2, and by reference number 230, a second step in the vectorization pipeline is to identify biharmonic control points to determine a biharmonic gradient fill for each piecewise smooth region of the target raster image. For example, the image processing device generally implements the biharmonic gradient fill based on a biharmonic (or bilaplacian) operator Δ², which is the square of the Laplacian operator. The biharmonic operator may be implemented on a pixel grid as a matrix applied to pixel colors, or on a triangulation of a shape to be colored as a matrix applied to mesh vertex colors. Furthermore, the biharmonic gradient fill is configured according to a set of colors x that least-squares minimizes a Laplacian energy, represented as ∥Δ²x∥². For example, to control the values associated with the biharmonic fill function, the user specifies colors at certain control points (also known as “handles”). For example, in a pixel grid, the control points are defined as a set of pixels p₁, . . . p_{N} in a region corresponding to the pixel grid or a continuous subset of the pixel grid, which are associated with user-specified color values c₁, . . . , c_{N}. Accordingly, a set of indexes I associated with the control points and the colors at each control point cᵢ provides the following constrained optimization problem:

$$arg {min}_{x} {‖ {Δ}^{2} x ‖}^{2} s . t . {x}_{i} = {c}_{i} ∀ i ∈ I \qquad ( 2 )$$

which the image processing device solves to identify the colors at each mesh vertex and then interpolate into the entire shape associated with the biharmonic gradient fill.

However, although the image processing device can determine the color values associated with each pixel in the raster image during vectorization, the indexes, colors, and number of control points are all unknown. Accordingly, in some implementations, the image processing device identifies a set of control points for each piecewise smooth region of the raster image to determine the indexes and the colors of the control points that are used as parameters for the biharmonic gradient fill function (e.g., based on the linear least squares problem described above). For example, given a set of target pixel or vertex values ƒ, the image processing device determines a biharmonic gradient function x that most closely approximates the target pixel or vertex values ƒ, subject to a sparsity loss with a configurable weight. For example, the sparsity loss is associated with a penalty for each control point that is identified in a region, such that the configurable weight of the sparsity loss allows the user to configure the tradeoff where a lower weight for the sparsity loss results in fewer control points, and a reconstruction with a higher fidelity (e.g., better image quality) and a higher complexity (e.g., larger file size and/or longer processing time). Similarly, a higher weight for the sparsity loss results in fewer control points, and a reconstruction with a reduced fidelity (e.g., lower image quality) and a lower complexity (e.g., smaller file size and/or shorter processing time).

In some implementations, the image processing device identifies the respective control points for each piecewise smooth region of the raster image by solving a derived unconstrained optimization problem that minimizes a biharmonic response of the function x that approximates the target pixel or vertex values ƒ, except at a sparse set of pixels that are then identified as the control points or handles. For example, the unconstrained optimization problem may be represented according to an optimization of an energy function:

E(x)=∥ƒ−x∥²+λ∥Δ²x∥_{sparsity} (3)

where the sparsity energy corresponds to a sum of pixel norms (e.g., represented by the ∥ƒ−x∥² term in Equation 3) and a pixel-wise L₀ gradient penalty for the number of pixels with a non-zero gradient or a similar sparsity-seeking loss (e.g., represented by the λ∥Δ²x∥_{sparsity} term in Equation 3), with λ representing the sparsity weight that defines the penalty associated with each control point (e.g., the parameter to control the tradeoff in fidelity for complexity).

Accordingly, for each piecewise smooth region or segment in the raster image, the image processing device identifies an approximation x that minimizes the energy function defined in Equation 3. For example, the image processing device identifies the approximation x that minimizes the energy function using a proximal optimization algorithm, such as a linearized alternating direction method of multipliers (ADMM) algorithm or an algorithm based on a primal-dual formulation (e.g., the Chambolle-Pock algorithm). The image processing device then identifies local maxima of |Δ²x|, which are designated the control points for the region. The image processing device then configures a respective color value for each control point, such that the indexes associated with the control points and the respective color values for the control points can be input to the biharmonic gradient fill function. For example, in some implementations, the image processing device identifies the respective color values for the control points based on the respective color values of xᵢ, or by solving the optimization problem described above in Equation 2 with known control points.

As further shown in FIG. 2, and by reference number 240, the image processing device then traces the piecewise smooth regions to convert pixel masks associated with the regions into Bezier shapes by fitting curves to the boundary (e.g., by computing Bezier curves or other mathematical representations bounding the shapes of the segmented regions). Each traced region is then filled using a biharmonic gradient fill based on the control points identified for the region and the corresponding color values associated with the control points. As further shown by reference number 250, the image processing device then generates a vector graphics file that is a biharmonic reconstruction of the raster image, which is returned to the user. The user may then edit the vector graphics image (e.g., by moving one or more control points, changing the color values for one or more control points, removing or adding one or more control points, and/or changing a spread associated with one or more control points, among other examples).

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

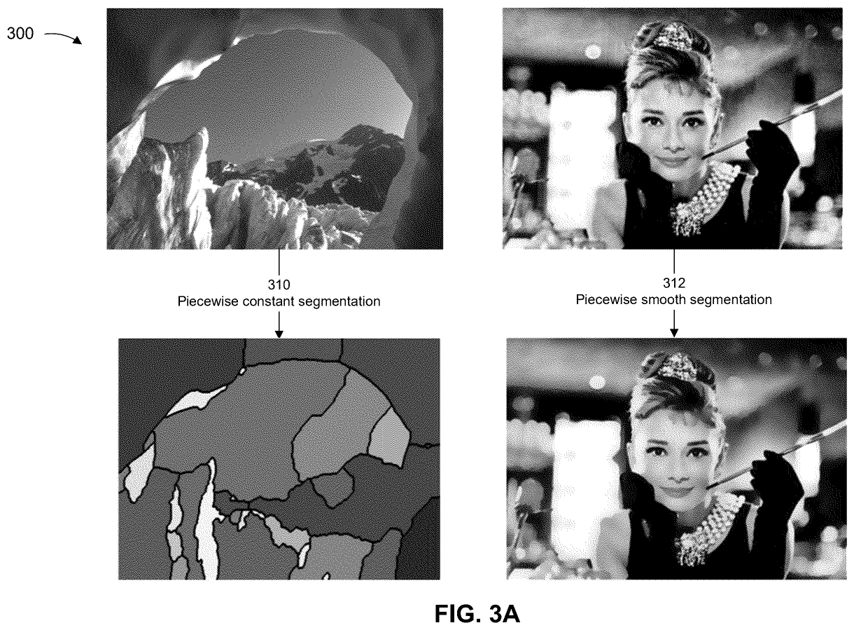

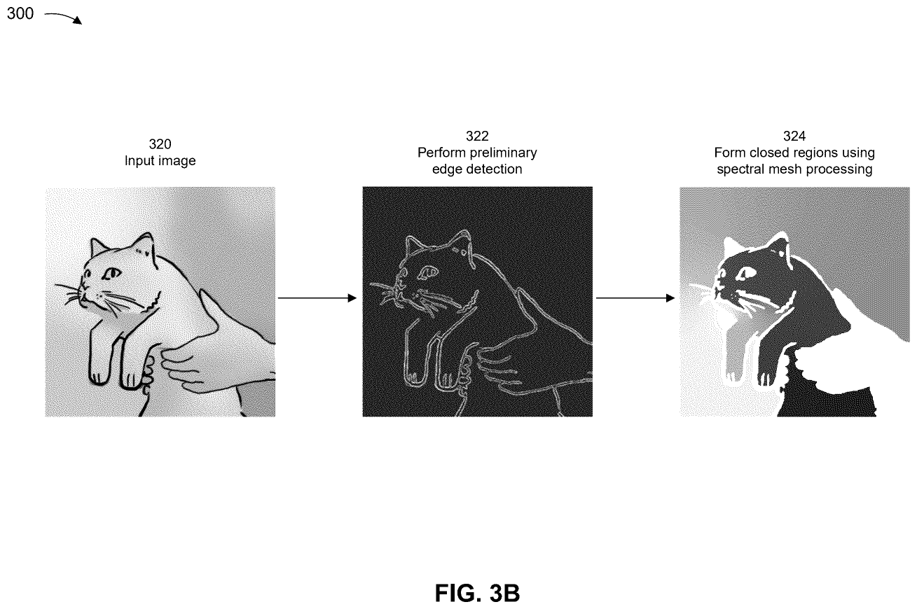

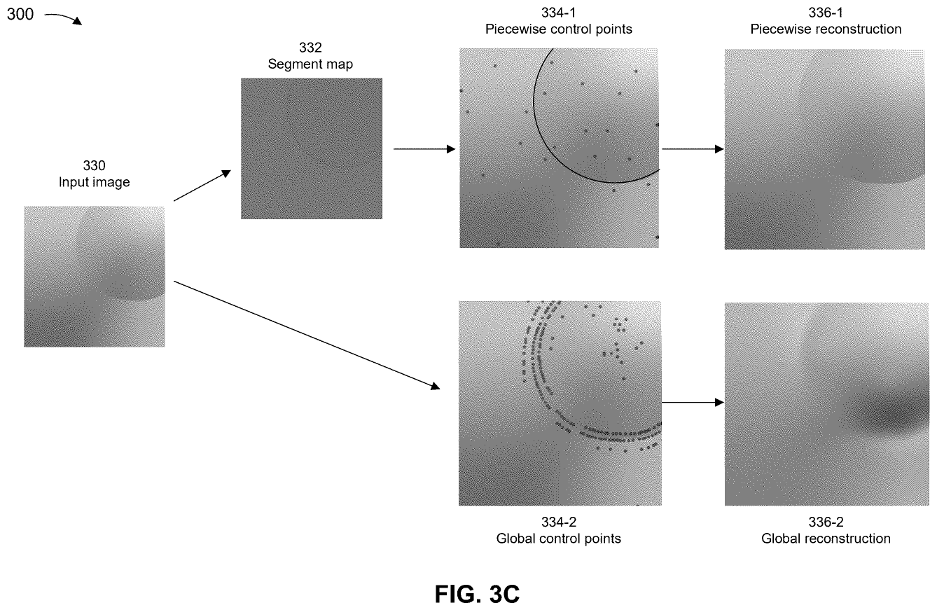

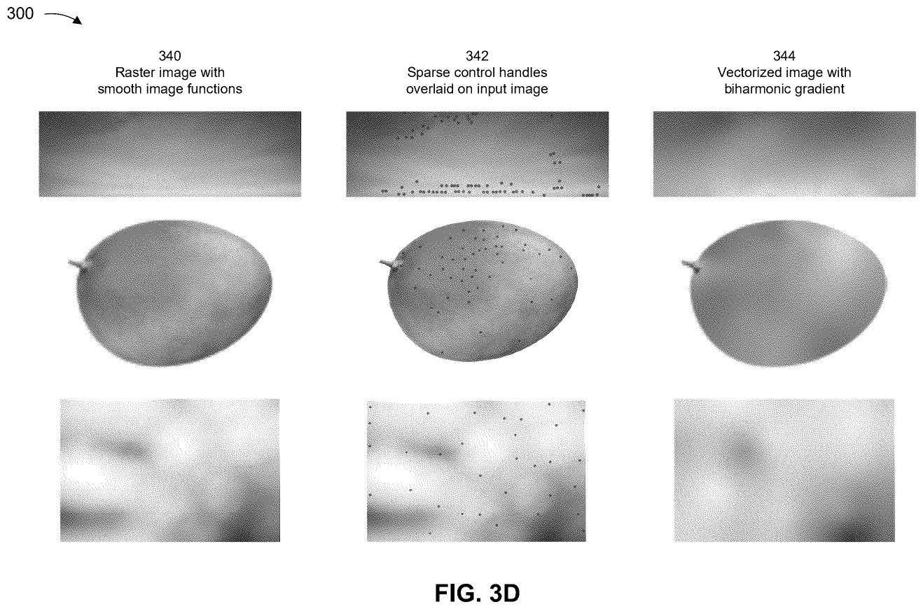

FIGS. 3A-3D are diagrams illustrating examples 300 associated with generating a vector graphics reconstruction of a raster image with one or more biharmonic gradients, according to some implementations of the present disclosure. More particularly, FIGS. 3A-3B provide examples to illustrate the segmentation of a raster image into closed, piecewise smooth regions, and FIGS. 3C-3D provide examples to illustrate techniques that may be used to identify the control points and corresponding color values that parameterize a biharmonic gradient fill function applied to one or more of the closed, piecewise smooth regions.

More particularly, as shown by reference number 310 in FIG. 3A, a raster image is segmented into piecewise constant regions using a Mumford-Shah functional or another suitable algorithm. For example, in the piecewise-constant segmentation, the raster image is segmented by finding connected components of pixels with equal colors, and each segment is then filled with a solid fill corresponding to the color of the pixels therein. As shown in FIG. 3A, the piecewise constant segmentation and solid fill falls short in capturing color blending and other expressive details in the original image.

Accordingly, to enable a freeform gradient fill, such as biharmonic diffusion, the image processing device described herein segments an input image into closed, piecewise smooth regions. For example, as shown by reference number 312, the raster image is pre-processed (e.g., smoothed) to reduce noise and fine details in the raster image, and the pre-processed image is segmented into connected components (or regions) that are closed, piecewise smooth, and sufficiently distinct in color (e.g., using spectral mesh segmentation techniques). For example, FIG. 3B illustrates an example segmentation of an input image into closed, piecewise smooth regions. For example, as shown by reference number 320, the image processing device receives an input image, which may be a raster image or another suitable image. As shown by reference number 322, the image processing device then pre-processes the input image, which includes smoothing the input image and performing preliminary edge detection such that the input image can be segmented into separate smooth regions that are free from interior high-frequency features (e.g., the detected edges are treated as boundaries for the regions). As shown by reference number 324, the image processing device then forms closed, piecewise smooth regions using spectral mesh processing techniques, where each piecewise smooth region is associated with an appropriate fill. For example, as described herein, the piecewise smooth regions include at least one region associated with a freeform gradient fill, such as a gradient fill based on biharmonic diffusion. Furthermore, in some cases, the piecewise smooth regions may include one or more regions with lower-order fills or other gradient fills (e.g., a solid fill may be applied in one or more regions where the color is relatively constant, a linear gradient fill may be applied in one or more regions where the color varies linearly along an axis, or a radial gradient fill may be applied in one or more regions where the color varies in a circular pattern).

As shown in FIG. 3C, the image processing device identifies a set of control points for one or more regions or segments of the input image associated with biharmonic color diffusion. For example, as shown by reference number 330, the image processing device receives an input image that includes one or more regions where colors diffuse and gradually blend in a freeform (e.g., non-linear or non-radial) manner. As shown by reference number 332, the image processing device segments the input image into separate piecewise smooth regions, resulting in a segment map where each segment or region is free from high-frequency features. As shown by reference number 334-1, the image processing device then identifies a set of control points for each region (e.g., two regions in the illustrated example) by solving a derived unconstrained optimization problem that minimizes the biharmonic response of a function x that approximates the target pixel or vertex values ƒ in the respective region, except at a sparse set of pixels that are then identified as the control points or handles (e.g., by minimizing a sparsity energy defined as a sum of pixel norms (e.g., represented by the ∥ƒ−x∥² term in Equation 3) and a pixel-wise L₀ gradient penalty for the number of pixels with a non-zero gradient or a similar sparsity-seeking loss (e.g., represented by the λ∥Δ²x∥_{sparsity} term in Equation 3), with λ defining a penalty associated with each control point. As shown by reference number 336-2, the image processing device then configures a respective color value for each control point, such that the indexes associated with the control points and the respective color values for the control points can be input to a biharmonic gradient fill function per region.

Alternatively, in some cases, the image processing device approximates the input image as a single biharmonic diffusion region (e.g., the entire input image is treated as one region or segment with a biharmonic gradient fill). For example, as shown by reference number 334-2, the image processing device similarly identifies a set of control points, except that the control points are identified globally for the entire input image rather than per region. However, because the input image includes a high-frequency interior feature, where a change in color values between adjacent or neighboring pixels satisfies (e.g., exceeds) a threshold (e.g., as shown by the edge separating the circular area in the upper-right corner from the rest of the input image), identifying the control points globally results in extraneous control points, because the image processing device attempts to approximate the edge when identifying the control points. As a result, the extraneous control points increase the complexity of the vectorization. In addition, as shown by reference number 336-2, approximating the input image as a single biharmonic diffusion region results in a poor fit for the biharmonic gradient fill, which is ill-suited to represent discontinuities such as the high-frequency edge. Accordingly, the image processing device approximates the entire input image as one biharmonic diffusion region only in cases where there are no interior edges or other high-frequency features detected.

As shown in FIG. 3D, some implementations described herein enable piecewise biharmonic reconstruction of raster images that include regions with diffused color blending. For example, referring to FIG. 3D, reference number 340 illustrates a set of raster images with smooth image functions, reference number 342 illustrates sparse control points or handles that are identified for one or more piecewise smooth regions of the raster images (e.g., the control points are shown as being overlaid on the original raster images), and reference number 344 illustrates infinitely scalable vectorized images that can be generated from vector graphics files that are created based on one or more biharmonic gradient fill functions parameterized according to the control points and corresponding color values for each region of the input image.

As indicated above, FIGS. 3A-3D are provided as example. Other examples may differ from what is described with regard to FIGS. 3A-3D.

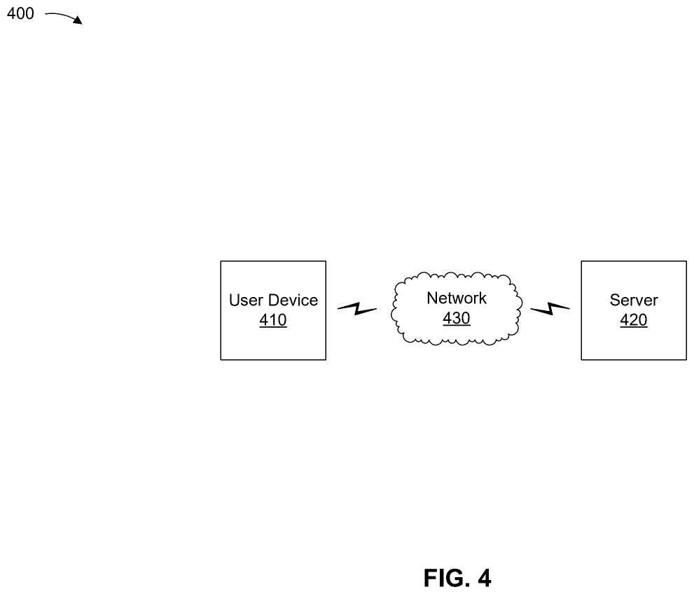

FIG. 4 is a diagram illustrating an example environment 400 in which a raster image with one or more biharmonic gradients may be converted to a vector graphics file, according to some implementations of the present disclosure. As shown in FIG. 4, the environment 400 may include a user device 410, a server 420, and a network 430. Devices in the environment 400 may interconnect via wired connections, wireless connections, or a combination thereof.

The user device 410 may include one or more devices capable of receiving, generating, storing, processing, and/or providing information associated with vectorizing a raster image based on biharmonic segmentation and reconstruction, as described elsewhere herein. In some implementations, the user device 410 may correspond to the image processing device shown in FIG. 1 and/or FIG. 2, and/or may perform one or more features in accordance with the aspects shown in FIGS. 3A-3D. For example, the user device 410 may execute an image processing application that can generate a vector graphics file corresponding to a biharmonic reconstruction of a raster image, may communicate with the server 420 to utilize resources of the server 420 to generate the vector graphics file, or may communicate with the server 420 to generate the vector graphics file using an image processing application executing on the server 420. The user device 410 may include a communication device and/or a computing device. For example, the user device 410 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The server 420 may include one or more devices capable of receiving, generating, storing, processing, providing, and/or routing information associated with vectorizing a raster image based on biharmonic segmentation and reconstruction, as described elsewhere herein. In some implementations, the server 420 may correspond to the image processing device shown in FIG. 1 and/or FIG. 2, and/or may perform one or more features in accordance with the aspects shown in FIGS. 3A-3D. The server 420 may include a communication device and/or a computing device. For example, the server 420 may include an application server, a client server, a web server, a database server, a host server, a proxy server, a virtual server (e.g., executing on computing hardware), or a server in a cloud computing system. In some implementations, the server 420 may include computing hardware used in a cloud computing environment, such as one or more serverless components (e.g., one or more serverless functions).

The network 430 may include one or more wired and/or wireless networks. For example, the network 430 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 430 enables communication among the devices of environment 400.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

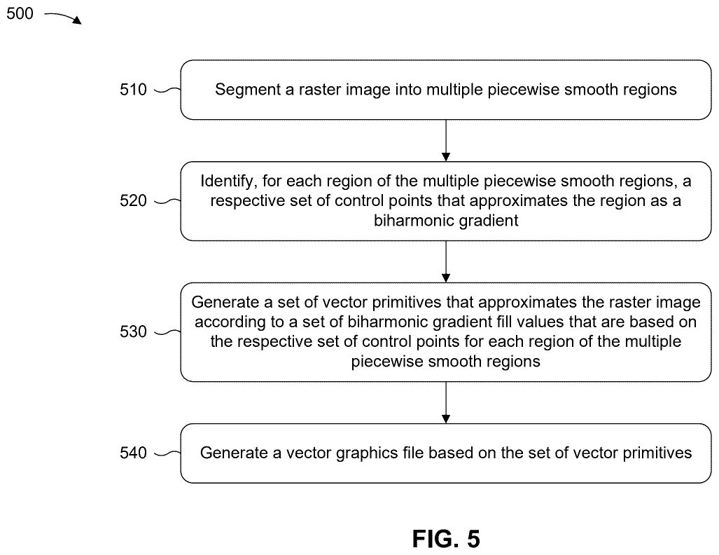

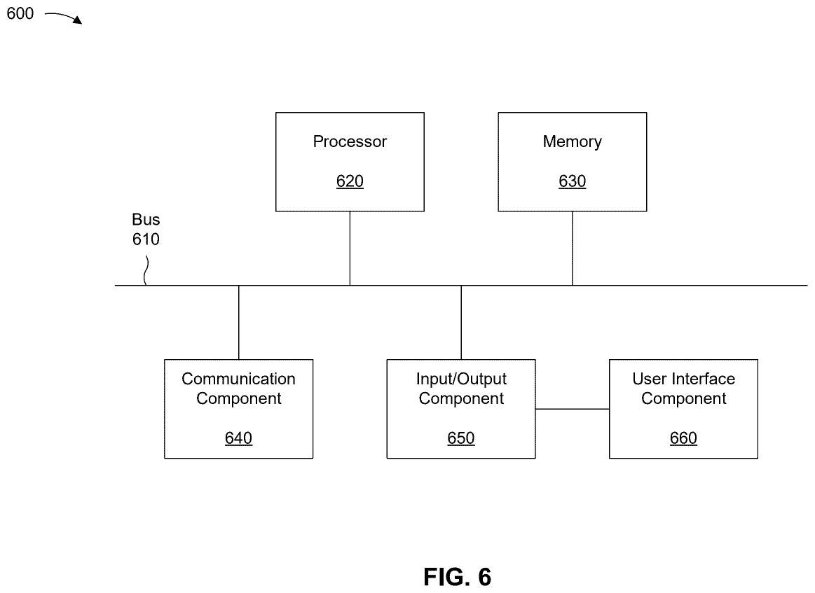

FIG. 5 is a flowchart of an example process 500 associated with biharmonic gradient segmentation and reconstruction. One or more process blocks of FIG. 5 are performed by an image processing device (e.g., the user device 410 and/or the server 420) and/or by another device or a group of devices separate from or including the image processing device. Additionally, or alternatively, one or more process blocks of FIG. 5 may be performed by one or more components of the device 600 depicted in FIG. 6, such as processor 620, memory 630, communication component 640, I/O component 650, or user interface component 660.

As shown in FIG. 5, process 500 includes segmenting a raster image into multiple piecewise smooth regions (block 510). For example, the image processing device may segment a raster image into multiple piecewise smooth regions, as described above.

As further shown in FIG. 5, process 500 includes identifying, for each region of the multiple piecewise smooth regions, a respective set of control points that approximates the region as a biharmonic gradient (block 520). For example, the image processing device may identify, for each region of the multiple piecewise smooth regions, a respective set of control points that approximates the region as a biharmonic gradient, as described above.

As further shown in FIG. 5, process 500 includes generating a set of vector primitives that approximates the raster image according to a set of biharmonic gradient fill values that are based on the respective set of control points for each region of the multiple piecewise smooth regions (block 530). For example, the image processing device may generate a set of vector primitives that approximates the raster image according to a set of biharmonic gradient fill values that are based on the respective set of control points for each region of the multiple piecewise smooth regions, as described above.

As further shown in FIG. 5, process 500 includes generating a vector graphics file based on the set of vector primitives (block 540). For example, the image processing device may generate a vector graphics file based on the set of vector primitives, as described above.

Process 500 may include additional aspects, such as any single aspect or any combination of aspects described below and/or in connection with one or more other processes described elsewhere herein.

In a first aspect, the respective set of control points for each region have a non-zero biharmonic response.

In a second aspect, alone or in combination with the first aspect, identifying the respective set of control points for each region of the multiple piecewise smooth regions comprises identifying a set of color values that minimizes a sparsity energy, wherein the sparsity energy comprises a sum of a first term based on a difference between the set of color values and target values associated with corresponding pixels in the raster image and a second term based on biharmonic responses associated with the set of color values, and identifying, among the set of color values that minimizes the sparsity energy, one or more local maxima for the biharmonic responses, wherein the set of control points corresponds to the one or more local maxima.

In a third aspect, alone or in combination with one or more of the first and second aspects, the set of color values that minimizes the sparsity energy are identified using a proximal optimization algorithm.

In a fourth aspect, alone or in combination with one or more of the first through third aspects, the second term is further based on a sparsity weight having a configurable value based on one or more of a target fidelity or a target complexity for the set of vector primitives that approximates the raster image.

In a fifth aspect, alone or in combination with one or more of the first through fourth aspects, the set of biharmonic gradient fill values are based on color values associated with the respective set of control points for each region of the multiple piecewise smooth regions.

In a sixth aspect, alone or in combination with one or more of the first through fifth aspects, the set of biharmonic gradient fill values are based on a solution to a system of linear least square conditions.

In a seventh aspect, alone or in combination with one or more of the first through sixth aspects, segmenting the raster image into the multiple piecewise smooth regions comprises detecting a set of edges in the raster image using a piecewise smoothing algorithm, and connecting the set of edges to form the multiple piecewise smooth regions using a spectral mesh segmentation algorithm.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

FIG. 6 is a diagram of example device 600 associated with biharmonic gradient segmentation and reconstruction. In some implementations, the device 600 corresponds to one or more of the user device 410 and/or the server 420 shown in FIG. 4. In some implementations, the user device 410 and/or the server 420 include one or more devices 600 and/or one or more components of the device 600. In the example shown in FIG. 6, the device 600 includes a bus 610, a processor 620, a memory 630, a communication component 640, an input/output (I/O) component 650, and/or a user interface component 660.

The bus 610 includes one or more components that enable wired and/or wireless communication among the components of the device 600. The bus 610 couples together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 includes a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 includes one or more processors capable of being programmed to perform one or more operations or processes described elsewhere herein.

The memory 630 includes volatile and/or nonvolatile memory, such as random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). In some implementations, the memory 630 is a non-transitory computer-readable medium. The memory 630 stores information, one or more instructions, and/or software (e.g., one or more software applications) related to the operation of the device 600. In some implementations, the memory 630 includes one or more memories that are coupled (e.g., communicatively coupled) to one or more processors (e.g., processor 620), such as via the bus 610. Communicative coupling between a processor 620 and a memory 630 enables the processor 620 to read and/or process information stored in the memory 630 and/or to store information in the memory 630.

The communication component 640 enables the device 600 to communicate with other devices via a wired connection and/or a wireless connection. For example, the communication component 640 may include a receiver, a transmitter, a transceiver, a modem, a network interface card, and/or an antenna.

The I/O component 650 enables the device 600 to receive input, such as user input and/or sensed input. For example, the I/O component 650 may include a touch screen, a keyboard, a keypad, a mouse, a button, a microphone, a switch, a sensor, a global positioning system sensor, a global navigation satellite system sensor, an accelerometer, a gyroscope, and/or an actuator. Additionally, or alternatively, the I/O component 650 enables the device 600 to provide output, such as via a display, a speaker, and/or a light-emitting diode. In some implementations, the I/O component 650 is controlled by an I/O controller to manage input and output signals for the device 600. In some cases, the I/O component 650 manages peripherals not integrated into the device 600. In some cases, the I/O component 650 represents a physical connection or port to an external peripheral. In some cases, the I/O controller represents or interacts with a modem, a keyboard, a mouse, a touchscreen, or a similar device. In some cases, the I/O controller is implemented as a component of a processor. In some cases, a user interacts with the device 600 via the I/O component 650 or via one or more hardware components controlled by the I/O controller.

The user interface component 660 enables a user to interact with the device 600 (e.g., via the I/O component 650). In some cases, the user interface component 660 includes an audio device, such as an external speaker system, an external display device such as a display screen, an input device (e.g., a remote-control device interfaced with a user interface directly or through the I/O controller), or a combination thereof. In some cases, the user interface component 660 includes a graphical user interface.

In some implementations, the device 600 performs one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry is used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, one or more components of the device 600 may perform one or more functions described as being performed by another set of components of the device 600.

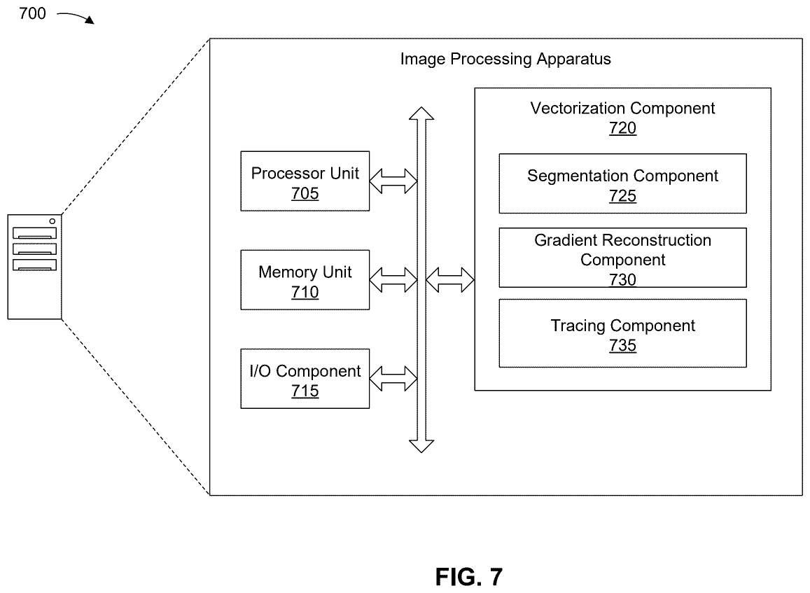

FIG. 7 is a diagram illustrating an example image processing apparatus 700 configured to generate a vector graphics reconstruction of a raster image with one or more biharmonic gradients, according to some implementations of the present disclosure. In some implementations, the image processing apparatus 700 corresponds to the image processing device shown and described with reference to FIGS. 1-2, the user device 410 and/or the server 420 shown and described with reference to FIG. 4, and/or the device 600 or one or more components of the device 600 shown and described with reference to FIG. 6. As shown in FIG. 7, the image processing apparatus 700 includes a processor unit 705, a memory unit 710, an I/O component 715, and a vectorization component 720. In some implementations, as shown, the vectorization component 720 includes a segmentation component 725, a gradient reconstruction component 730, and a tracing component 735.

The processor unit 705 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In some cases, the processor unit 705 is configured to operate a memory array using a memory controller. In other cases, a memory controller is integrated into the processor unit 705. In some cases, the processor unit 705 is configured to execute computer-readable instructions stored in the memory unit 710 to perform various functions. In some implementations, the processor unit 705 includes special purpose components for modem processing, baseband processing, digital signal processing, or transmission processing. According to some implementations, the processor unit 705 comprises one or more processors 620 described with reference to FIG. 6.

The memory unit 710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of the processor unit 705 to perform various functions described herein.

In some cases, the memory unit 710 includes a basic input/output system (BIOS) that controls basic hardware or software operations, such as an interaction with peripheral components or devices. In some cases, the memory unit 710 includes a memory controller that operates memory cells of the memory unit 710. For example, the memory controller may include a row decoder, column decoder, or both. In some cases, the memory cells within the memory unit 710 store information in the form of a logical state. According to some aspects, the memory unit 710 is an example of the memory 630 described with reference to FIG. 6.

According to some aspects, the image processing apparatus 700 uses one or more processors of the processor unit 705 to execute instructions stored in the memory unit 710 to perform functions described herein. For example, the image processing apparatus 700 may generate a vector graphics file that includes parameters associated with one or more biharmonic gradient fill functions to approximate color diffusion in one or more regions of an input image.

The I/O component 715 receives inputs from and transmits outputs of the image processing apparatus 700 to other devices or users. For example, the I/O component 715 receives inputs corresponding to one or more input images and transmits outputs corresponding to one or more vector graphics files that include vector primitives to represent regions, shapes, lines, points, and fills, including one or more biharmonic gradient gills, that approximate the one or more input images. According to some aspects, the I/O component 715 is an example of the I/O component 650 described with reference to FIG. 6.

In some implementations, as described herein, the vectorization component 720 may be configured to generate one or more vector graphics files that include vector primitives to represent regions, shapes, lines, points, and fills, including one or more biharmonic gradient gills, that approximate (e.g., vectorize) the one or more input images. For example, the segmentation component 725 may segment a raster image into multiple piecewise smooth regions. The gradient reconstruction component 730 may identify, for each region of the multiple piecewise smooth regions, a respective set of control points that approximates the region as a biharmonic gradient. The tracing component 735 may trace the piecewise smooth regions to convert pixel masks associated with the regions into vector primitives, such as shapes, points, lines, and curves, and may generate a set of vector primitives that approximates the raster image according to a set of biharmonic gradient fill values that are based on the respective set of control points that the gradient reconstruction component 730 identified for each region of the multiple piecewise smooth regions. The vectorization component 720 may then generate a vector graphics file based on the set of vector primitives.

The number and arrangement of components shown in FIG. 6 are provided as an example. The device 600 may include additional components, fewer components, different components, or differently arranged components than those shown in FIG. 6. Additionally, or alternatively, one or more components of the device 600 may perform one or more functions described as being performed by another set of components of the device 600.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
segmenting a raster image into multiple piecewise smooth regions;
identifying, for each region of the multiple piecewise smooth regions, a respective set of control points that approximates the region as a biharmonic gradient;
generating a set of vector primitives that approximates the raster image according to a set of biharmonic gradient fill values that are based on the respective set of control points for each region of the multiple piecewise smooth regions; and
generating a vector graphics file based on the set of vector primitives.

2. The method of claim 1, wherein the respective set of control points for each region have a non-zero biharmonic response.

3. The method of claim 1, wherein identifying the respective set of control points for each region of the multiple piecewise smooth regions comprises:
identifying a set of color values that minimizes a sparsity energy, wherein the sparsity energy comprises a sum of a first term based on a difference between the set of color values and target values associated with corresponding pixels in the raster image and a second term based on biharmonic responses associated with the set of color values; and
identifying, among the set of color values that minimizes the sparsity energy, one or more local maxima for the biharmonic responses, wherein the set of control points corresponds to the one or more local maxima.

4. The method of claim 3, wherein the set of color values that minimizes the sparsity energy are identified using a proximal optimization algorithm.

5. The method of claim 3, wherein the second term is further based on a sparsity weight having a configurable value based on one or more of a target fidelity or a target complexity for the set of vector primitives that approximates the raster image.

6. The method of claim 1, wherein the set of biharmonic gradient fill values are based on color values associated with the respective set of control points for each region of the multiple piecewise smooth regions.

7. The method of claim 1, wherein the set of biharmonic gradient fill values are based on a solution to a system of linear least square conditions.

8. The method of claim 1, wherein segmenting the raster image into the multiple piecewise smooth regions comprises:
detecting a set of edges in the raster image using a piecewise smoothing algorithm; and
connecting the set of edges to form the multiple piecewise smooth regions using a spectral mesh segmentation algorithm.

9. A system, comprising:
a memory component; and
a processing device coupled to the memory component, the processing device to:
segment an input image into one or more piecewise smooth regions;
identify, for each region of the one or more piecewise smooth regions, a respective set of control points that approximates the region as a biharmonic gradient, wherein the respective set of control points associated with each region have a non-zero biharmonic response;
generate a set of vector primitives that approximates the input image according to a set of biharmonic gradient fill values, wherein the set of biharmonic gradient fill values are based on color values for the respective set of control points associated with each region of the one or more piecewise smooth regions; and
generate a vector graphics file based on the set of vector primitives.

10. The system of claim 9, wherein the processing device, to identify the respective set of control points for each region of the one or more piecewise smooth regions, is to:
identify a set of color values that minimizes a value of a parameter based on a difference between the set of color values and target values associated with corresponding pixels in the input image and biharmonic responses associated with the set of color values; and
identify, among the set of color values that minimizes the value of the parameter, one or more local maxima for the biharmonic responses, wherein the set of control points corresponds to the one or more local maxima.

11. The system of claim 10, wherein the processing device, to identify the set of color values that minimizes the value of the parameter, is to:
identify the set of color values the minimizes the value of the parameter using a linearized alternating direction method of multipliers algorithm.

12. The system of claim 10, wherein the processing device, to identify the set of color values that minimizes the value of the parameter, is to:
identify the set of color values the minimizes the value of the parameter using a Chambolle-Pock algorithm.

13. The system of claim 10, wherein the value of the parameter is further based on a sparsity weight having a configurable value based on one or more of a target fidelity or a target complexity for the set of vector primitives that approximates the input image.

14. The system of claim 9, wherein the processing device, to segment the input image into the one or more piecewise smooth regions, is to:
detect a set of edges in the input image using a piecewise smoothing algorithm; and
connect the set of edges to form the one or more piecewise smooth regions using a spectral mesh segmentation algorithm.

15. A method, comprising:
detecting a set of edges in an input image using a piecewise smooth functional;
forming a set of closed, piecewise smooth regions based on the set of edges using a spectral processing algorithm;
identifying, for each region of the set of closed, piecewise smooth regions, a respective set of control points that approximates the region as a biharmonic gradient;
generating a set of vector primitives that approximates the input image according to a set of biharmonic gradient fill values that are based on the respective set of control points for each region of the set of closed, piecewise smooth regions; and
generating a vector graphics file based on the set of vector primitives.

16. The method of claim 15, wherein the respective set of control points for each region have a non-zero biharmonic response.

17. The method of claim 15, wherein identifying the respective set of control points for each region of the set of closed, piecewise smooth regions comprises:
identifying a set of color values that minimizes a sparsity energy, wherein the sparsity energy comprises a sum of a first term based on a difference between the set of color values and target values associated with corresponding pixels in the input image and a second term based on biharmonic responses associated with the set of color values; and
identifying, among the set of color values that minimizes the sparsity energy, one or more local maxima for the biharmonic responses, wherein the set of control points corresponds to the one or more local maxima.

18. The method of claim 17, wherein the second term is further based on a sparsity weight having a configurable value based on one or more of a target fidelity or a target complexity for the set of vector primitives that approximates the input image.

19. The method of claim 15, wherein the set of biharmonic gradient fill values are based on color values associated with the respective set of control points for each region of the set of closed, piecewise smooth regions.

20. The method of claim 15, wherein the set of biharmonic gradient fill values are based on a solution to a system of linear least square conditions.
